(19) United States
(12) Patent Application Publication
(10) Pub. No.: US 2010/0102173 A1
(43) Pub. Date: Apr. 29, 2010

(54) Light Aircraft Stabilization System

(76) Inventors: Michael L. Everett, El Paso, TX (US); Louis J. Everett, El Paso, TX (US); Mario Ruiz, El Paso, TX (US)

Correspondence Address: FULBRIGHT & JAWORSKI L.L.P., 600 CONGRESS AVE., SUITE 2400, AUSTIN, TX, 78701, US

(21) Appl. No.: 12/603,321

(22) Filed: Oct. 21, 2009

Related U.S. Application Data
(60) Provisional application No. 61/107,129, filed on Oct. 21, 2008.

(51) Int. Cl. B64C 13/16; G05D 1/00

(52) U.S. Cl. 244/175

(57) ABSTRACT

Control systems, controllers, systems, and methods of stabilizing a light aircraft during flight and/or ground maneuvers, such as by detecting and/or correcting undesired yaw characteristic, such as, for example, yaw angle, yaw rate, and/or yaw fluctuations.

### RELATED APPLICATIONS

This application claims priority U.S. Provisional Patent Application No. 61/107,129, filed Oct. 21, 2008, which is incorporated by reference in its entirety.

### BACKGROUND

1. Field of the Invention

The present invention relates generally to control of light aircraft. More particularly, but not by way of limitation, the present invention relates to control of yaw of light aircraft such as, for example, during takeoff and/or landing and/or flight.

2. Background Information

Various automated or semi-automated control systems have been used to control vehicles or to limit motion of vehicles. For example, anti-lock brake systems (ABS) are known for preventing the wheels of an automobile (e.g., car, truck, van, etc.) from “locking up” during motion of the automobile. ABS typically operates by releasing brake pressure (e.g., in a pulsed fashion) to ensure that wheels continue to turn and thereby prevent tires from losing traction during operation of a car. ABS systems typically override the driver's input (e.g., will not allow wheels to lock up no matter how hard a driver presses on the brake pedal). Such ABS systems are generally not “auto-pilot” systems. That is, they do not allow a driver of an automobile to simply input a desired course and allow the automobile to direct itself. Nor do such ABS systems typically alter or adjust the path along which the driver steers or directs the automobile.

Auto-pilot control systems have been used for commercial aircraft, but are typically cost-prohibitive for light aircraft (e.g., personal aircraft and/or smaller aircraft with propeller or turbo-prop engines). Such auto-pilot or “fly-by-wire” systems typically permit a pilot to enter a desired course and allow the auto-pilot system to direct the plane along the desired course. Such auto-pilot systems typically control the plane in lieu of input from the pilot, rather than in conjunction with, or as a supplement to, pilot input. Such auto-pilot systems are typically require complex electronics and programming (e.g., programming that is highly specific to a individual model of aircraft) that is generally cost prohibitive for light aircraft. Further, the complexity of typical auto-pilot systems may make it difficult and/or cost prohibitive to retrofit an auto-pilot system to existing light aircraft.

### SUMMARY

The present disclosure includes embodiments of control systems and methods for controlling light aircraft. As used in this disclosure, “light aircraft” refers to general aviation (GA) aircraft (e.g., single-pilot GA aircraft), as such aircraft are understood to be distinct from commercial aviation aircraft.

Some embodiments of the present control systems for light aircraft comprise: a controller configured to receive a signal from a yaw sensor of a light aircraft having a brake system the controller also being configured: to be coupled to the light aircraft such that the controller is in communication with the brake system of the aircraft; and such that if an undesired yaw characteristic of the aircraft is detected, the controller will send one or more signals to increase effective brake pressure in a portion of the brake system to decrease the undesired yaw characteristic.

In some embodiments, the controller is configured to receive a signal from a yaw sensor that comprises a gyroscope. In some embodiments, the controller is configured to receive a signal from a yaw sensor that comprises one or more accelerometers. In some embodiments, the controller is configured to receive a signal from a yaw sensor comprising two rotation sensors each coupled to a different wheel of the aircraft. In some embodiments, the controller is configured to measure the direction of a single wheel that is pivotally coupled to the aircraft.

In some embodiments, the controller is configured to detect an undesired yaw characteristic if a measured yaw angle deviates from an expected yaw angle by a deviation limit. In some embodiments, the controller is configured to detect an undesired yaw characteristic if a measured yaw rate deviates from an expected yaw rate by a deviation limit. In some embodiments, the controller is configured to receive a signal from a steering input sensor of a light aircraft to determine an expected yaw change. In some embodiments, the controller is configured to detect an undesired yaw characteristic if fluctuation in measure yaw rate exceeds a fluctuation limit. In some embodiments, the controller is configured such that if the measured yaw angle is greater than the expected yaw angle, the controller will increase effective brake pressure at a wheel on the right side of the aircraft, and where the controller is configured such that if the measured yaw angle is less than the expected yaw angle, the controller will increase effective brake pressure at a wheel on the left side of the aircraft. In some embodiments, the controller is configured such that if the measured yaw characteristic approaches a predetermined maximum, the controller will signal to the pilot that the aircraft is in danger of rolling over.

In some embodiments, controller is configured such that if the measured yaw characteristic approaches a predetermined maximum, the controller will modify effective brake pressure in a portion of the brake system to reduce the likelihood of the aircraft rolling over. In some embodiments, the controller is configured such that if the measured yaw characteristic approaches a predetermined maximum, the controller will actuate one or more additional steering systems of the aircraft to reduce the likelihood of the aircraft rolling over. In some embodiments, the one or more additional steering systems comprise one or more systems selected from the group consisting of: the propulsion system, and the primary flight control system. In some embodiments, the controller is configured such that the controller will not reduce the brake pressure below the brake pressure caused by a pilot's actuation of the brake system.

Some embodiments of the present control systems further comprise: a hydraulic pump configured to be coupled to a brake-fluid reservoir and brake lines of a light aircraft; two valves configured to be coupled to the controller, the pump, the brake fluid reservoir, and different brake lines, each valve corresponding to wheels on different sides of the aircraft, each valve configured such that when the valve is in a first position brake fluid is permitted to flow from the brake line to the reservoir but not from the pump to the brake line, and when the valve is in a second position brake fluid is permitted to flow from the pump into the brake line; and a yaw sensor configured to be coupled to the controller and a light aircraft to detect one or more yaw characteristics of the light aircraft. In some embodiments, the hydraulic pump is configured to be coupled to the controller such that the controller can send a signal to actuate the pump to provide varying levels of pressure in the brake lines. In some embodiments, the valves are configured to be coupled to the controller such that the controller can send a signal to actuate the valves to provide varying levels of pressure in the brake lines.

Some embodiments of the present control systems further comprise: one or more hydraulic cylinders configured to be coupled to a brake-fluid reservoir and brake lines of a light aircraft; one or more servos each configured to be coupled to a different one of the one or more hydraulic cylinders; and a yaw sensor configured to be coupled to the controller and a light aircraft to detect one or more yaw characteristics of the light aircraft. In some embodiments, the one or more servos are configured to be coupled to the controller such that the controller can send a signal to actuate each servo to in turn actuate a coupled hydraulic cylinder to provide varying levels of pressure in the brake lines. In some embodiments, the valves are configured to be coupled to the controller such that the controller can send a signal to actuate the valves to provide varying levels of pressure in the brake lines.

Some embodiments of the present control systems for light aircraft comprise: a controller configured to receive a signal from a yaw sensor of a light aircraft having one or more steering systems, the controller also being configured: to be coupled to the aircraft such that the controller is in communication with the one or more steering systems of the aircraft, and such that if an undesired yaw characteristic is detected, the controller will send one or more signals to actuate one or more steering systems of the aircraft to reduce the undesired yaw characteristic. In some embodiments, the controller is configured to send a signal to one or more steering systems selected from the group consisting of: the brake system, the propulsion system, and the primary flight control system.

Any embodiment of any of the present systems and/or methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 depicts a bottom view of a light aircraft having one of the present control systems.

FIG. 2 depicts a block diagram of the control system of FIG. 1.

FIG. 3 depicts a diagram of the hydraulic components of the control system of FIG. 1.

FIG. 4A-4D depict various views of an alternative embodiment of a brake system controller suitable for use with the present control systems.

### DESCRIPTION OF ILLUSTRATIVE EMBODIMENTS

The term “coupled” is defined as connected, although not necessarily directly, and not necessarily mechanically; two items that are “coupled” may be integral with each other. The terms “a” and “an” are defined as one or more unless this disclosure explicitly requires otherwise. The terms “substantially,” “approximately,” and “about” are defined as largely but not necessarily wholly what is specified, as understood by a person of ordinary skill in the art.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method that “comprises,” “has,” “includes” or “contains” one or more steps possesses those one or more steps, but is not limited to possessing only those one or more steps. Likewise, a control system that “comprises,” “has,” “includes” or “contains” one or more elements possesses those one or more elements, but is not limited to possessing only those elements. For example, in a control system that comprises a controller, the system includes the specified elements but is not limited to having only those elements. For example, such a system could also include one or more valves configured to be coupled to (and/or coupled to) the controller.

Further, a device or structure that is configured in a certain way is configured in at least that way, but it can also be configured in other ways than those specifically described.

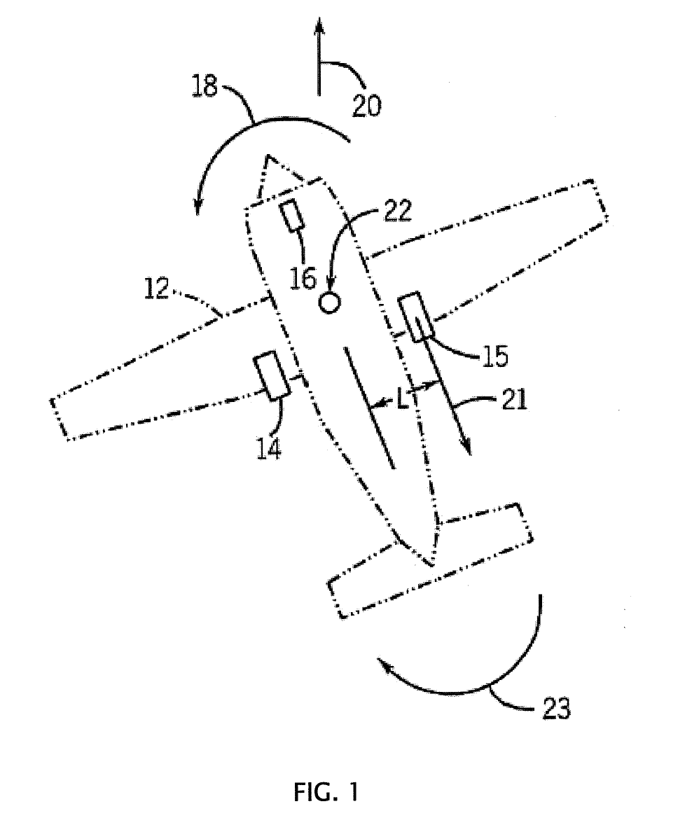

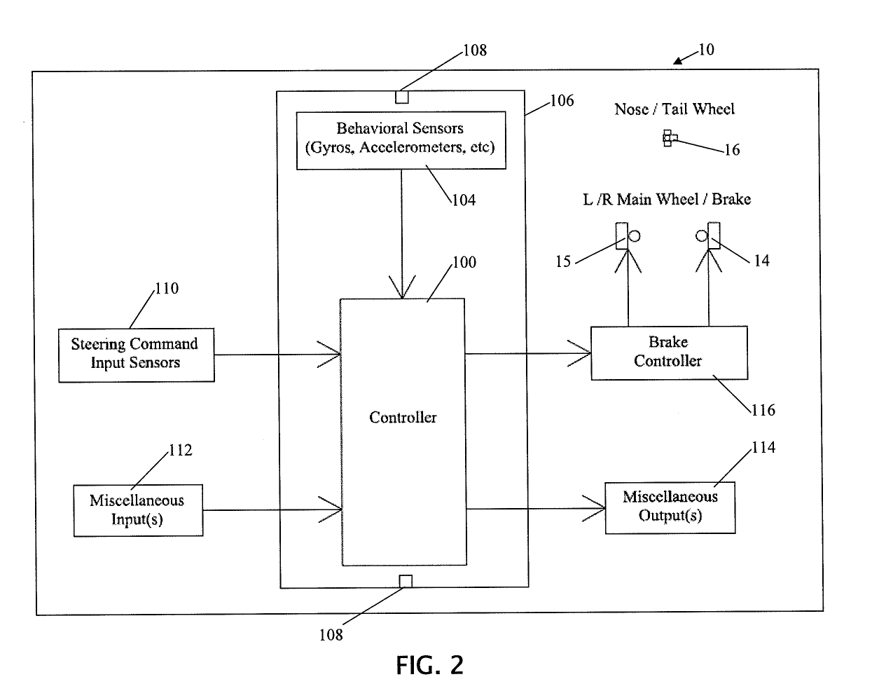

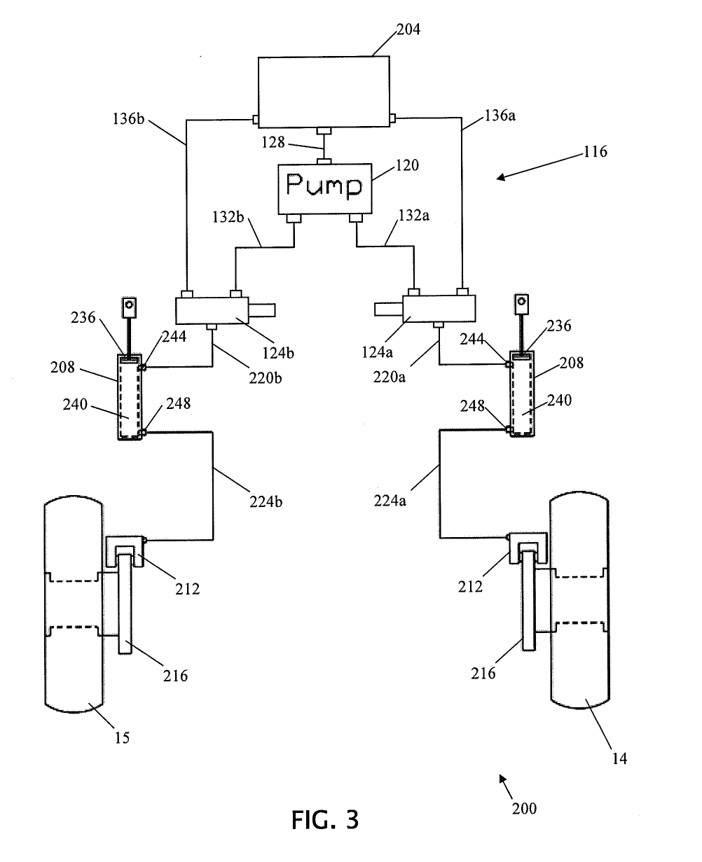

Referring now to the drawings, and more particularly to FIGS. 1-3, FIG. 1 depicts one of the present control systems 10 coupled to a light aircraft 12; FIG. 2 depicts a block diagram of control system 10; and FIG. 3 depicts a diagram of the hydraulic components of control system 10. Light aircraft 12 may be referred to in this disclosure interchangeably as aircraft 12. Similarly, control system 10 may be referred to in this disclosure interchangeably as system 10. In the embodiment shown, aircraft 12 comprises a single-engine Piper PA-28-180. In FIG. 1, control system 10 is coupled to an interior portion of aircraft 12 such that system 10 is not visible in the figure. For example, control system 10 can be coupled to the aircraft in any suitable location, such as, for example, in the fuselage, in a wing, in the cockpit, and/or in any other suitable location that permits control system 10 to function as described in this disclosure and/or provides protection for control system 10.

Aircraft 12 comprises a first (right, when viewed from the top of the aircraft facing the front of the aircraft) wheel 14, a second (left, when viewed from the top of the aircraft facing the front of the aircraft) wheel 15, and a front wheel 16 (collectively, landing gear wheels). Although aircraft 12 is shown with a front (e.g., center) wheel 16, other aircraft for which the present control systems (e.g., 10) can be configured may alternatively comprise a rear (e.g., center) wheel. In some embodiments of aircraft 12, right wheel 14 and left wheel 15 can each comprise multiple wheels (e.g., two, three, four, or more) coupled to a single landing gear support or arm (e.g., a left landing gear arm or a right landing gear arm). As indicated in FIG. 1, the left and right wheels (e.g., wheel 15) are laterally offset (disposed a distance away from) by a distance L from the center of mass 22 (and/or the longitudinal axis) of aircraft 12. System 10 can be configured to function with various aircraft (e.g., those without direct wheel-steering control, and/or those with direct wheel-steering control of only one wheel such as a nose or tail wheel).

In certain embodiments, system 10 is configured to counteract undesired yaw characteristics (e.g., yaw or rotation around a vertical (relative to the aircraft) passing through the aircraft, such as relative to a desired direction of motion; and/or yaw rate such as, for example, during an intended turning of the aircraft) of an aircraft 12, such as, for example, during takeoff or landing of aircraft 12 when wheels 14 and 15 are in contact with the runway (or similar surface). For example, in FIG. 1, arrow 18 indicates an undesired yaw relative to an intended or desired direction 20 of motion of the aircraft. An undesired yaw characteristic can be sensed by one or more yaw sensors (described in more detail below) such that system 10 can detect or identify an undesired yaw characteristic and respond to reduce and/or eliminate the undesired yaw characteristic. In the embodiment shown, system 10 is configured to effect a corrective force (e.g., by braking wheel 15) in direction 21. A corrective force in direction 21, multiplied by the distance L (moment arm) from center of mass 22, results in a rotational moment to create a corrective rotation (e.g., in direction 23) to reduce and/or eliminate the undesired yaw characteristic.

In some embodiments of system 10, controller 100 is configured to receive signals from yaw sensors and the like to detect unwanted deviations in yaw angle or yaw rate (e.g., from a desired heading). For example, such deviations maybe caused by variations in engine-born forces such as torque, p-factor, slipstream, and gyroscopic precession, as well as meteorological forces such as experienced in strong winds such as cross wind gusts. Controller 100 can be configured to sense or receive signals from sensors measuring rudder and/or steering input (e.g., from a pilot) such that the controller can determine and/or approximate an expected yaw angle, rate of yaw, or other yaw characteristic to compare to measured yaw characteristics. When an undesired yaw characteristic of the aircraft is detected, controller 100 can be configured to send or output a signal to actuate one or more steering systems (e.g., one or more brakes) to exert a corrective force in an amount calculated, approximated, and/or necessary to reduce the undesired yaw characteristic (e.g., to bring the aircraft back to the desired direction or yaw angle, and/or maintain the aircraft on the desired heading). The braking force can be applied via various methods. Generally, the function of certain embodiments of the present systems (e.g., those that can implement a corrective force via wheel brakes of an aircraft while the wheels (e.g., tires) are in contact with or coupled to a surface such as a runway) may be described as relating to corrective control of ground based maneuvers in (or of) an aircraft (e.g., aircraft 12).

In some embodiments, system 10 comprises a controller 100 configured to receive a signal from a yaw or behavioral sensor 104 (e.g., of aircraft 12) configured to sense one or more yaw characteristics of the aircraft. In the embodiment shown, aircraft 12 has or includes one or more steering systems (e.g., systems that can be used to steer the aircraft) comprising, for example, a brake system (e.g., 200, as shown in FIG. 3) corresponding to wheels 14 and 15 (and/or wheel 16), a propulsion system, and a primary flight control system. In the embodiment shown, propulsion system of aircraft 12 comprises a single engine, but in other light aircraft may comprise dual engines (e.g., one coupled to each wing). The primary flight control system comprises wing flaps (e.g., ailerons and/or elevators), a rudder, and the like for directing the aircraft's motion during flight, and/or to some extent on the ground.

In some embodiments, system 10 comprises a controller (e.g., 100) configured to receive a signal from a yaw sensor (e.g., 104) of a light aircraft (e.g., 12) having one or more steering systems, where the controller is also configured: to be coupled to the aircraft such that the controller is in communication with the one or more steering systems of the aircraft, and such that if an undesired yaw characteristic is detected, the controller will send one or more signals to actuate one or more steering systems of the aircraft to reduce the undesired yaw characteristic. In some embodiments, the controller is configured to send a signal to one or more steering systems selected from the group consisting of: the brake system, the propulsion system, and the primary flight control system. As described above, a corrective force in direction 21 can be created with any of the steering systems to rotate the aircraft in direction 23 and reduce or eliminate the undesired yaw characteristic. For example, in embodiments of system 10 coupled to an aircraft that has twin engines (one coupled to each wing), the propulsion system (e.g., the engine on the side of wheel 14) can be accelerated or otherwise actuated to increase thrust so as to rotate the aircraft in direction in direction 23. By way of another example, primary flight control system (e.g., one or more flaps on the wing on the side of wheel 15 can be raised to increase drag on the side of 15 to rotate the aircraft in direction 23. By way of further examples, controller 100 can be configured to send a signal to actuate various steering systems to create corrective forces (e.g., rudder control or other moveable surface(s), deflection of trim tabs or flaps, differential thrust in multiple engine airframes such as by alteration of power application and/or by propeller pitch setting, and the like).

In the embodiment shown, system 10 comprises controller 100 and yaw sensor 104. In some embodiments, aircraft 12 can comprise one or more yaw sensors 104 independent of system 10 (e.g., to which system 10 can be configured to be coupled) such that controller 100 can be configured to be coupled (and can be coupled) to the independent yaw sensor(s) 104 of the aircraft. Yaw sensor 104 can be coupled to aircraft 12 physically separate from controller 100 or can be integrated into a common housing 106 with controller 100 such that if controller 100 is coupled to aircraft 12, sensor 104 is also coupled to aircraft 12. In embodiments in which sensor 104 shares a common housing 106 with controller 100, housing 106 can include a marker (or indicator) 108 indicating an appropriate, desired, and/or functional orientation of housing 106 relative to aircraft 12. For example, marker 108 can be disposed at a forward end of housing 106 corresponding to the front of aircraft 12 (e.g., that should face the front of aircraft 12 when housing 106 is coupled to or otherwise installed on or in aircraft 12) and/or at a rearward end of housing 106 corresponding to the rear of aircraft 12.

In the embodiment shown, system 10 also comprises one or more steering input command sensors 110 coupled to one or more steering systems of aircraft 12. For example, sensors 110 can be coupled to steering yoke of the aircraft, to the brake pedals of the aircraft, and/or any other steering system of the aircraft such that sensors 110 can measure or otherwise sense information from or about the steering systems, from which information controller 100 can determine an intended or directed course or direction of the aircraft (e.g., such that controller 100 can determine an expected yaw characteristic (e.g., yaw angle and/or yaw rate) to which a measured yaw characteristic can be compared. Steering command input sensors 110 can be coupled to controller 100 and configured such that controller 100 can receive one or more signals from sensors 110 indicative of the information from or about the one or more steering systems of the aircraft and/or the desired or directed path of the aircraft. Sensors 110 can comprise, for example, rotary and/or linear encoders, linear and/or rotary potentiometers, and/or the like. Sensors 110 can also comprise fixed-position sensors or switches to aid in the calibration of others of sensors 110. For example, by placing fixed-position sensors or switches of either contact or non-contact types at predetermined locations such as, for example at neutral steering position, maximum and minimum steering positions, and the like, information can be attained to validate the information of (and/or calibrate) others of sensors 110 (e.g., encoders, potentiometers). Controller 100 can also be configured to utilize this sensor configuration and/or technique can to calibrate any of the other components of system 10 in substantially real-time (e.g., “on the fly”). In some embodiments, sensors 110 can be coupled to aircraft 12 independent of system 110 (e.g., may be installed by the manufacturer of the aircraft) such that controller 100 can be configured to be coupled to existing sensors 110 when system 10 is installed on (e.g., coupled to) aircraft 12. In other embodiments, sensors 110 can be installed on or coupled to aircraft 12 with system 10.

Controller 100 and/or yaw sensor 104 can be configured to sense and or detect a variety of yaw characteristics. For example, in some embodiments, controller 100 is configured to detect an undesired yaw characteristic if a measured yaw angle deviates from an expected yaw angle by a deviation limit. A deviation limit may include a deviation value below which the controller will not detect or identify an undesired yaw characteristic (and thus, will not react or send a signal to reduce the undesired yaw characteristic), and above which controller 100 will detect or identify an undesired yaw characteristic. Such a range or deviation limit may allow for error in yaw sensor 104 and/or may permit some deviation that is not expected to cause an adverse reaction or result for the aircraft. For example, a deviation limit may be set at, between, greater than, or less than any of about (and/or substantially equal to) zero, one, two, three, four, five, six, seven, eight, nine, ten, or more degrees deviation from an expected yaw angle (e.g., in the illustration of FIG. 1, where a deviation limit is set at three degrees, controller 100 will not detect and undesired yaw characteristic until the measured yaw angle deviates by more than three degrees from the expected yaw angle of zero degrees for the straight-line desired path of motion in direction 20). In some embodiments, controller 100 is configured such that if the measured yaw angle is greater than (is counterclockwise relative to the expected yaw angle when viewing the aircraft from the top) the expected yaw angle, the controller will increase effective brake pressure at a wheel (e.g., 14) on the right side of the aircraft, and where the controller is configured such that if the measured yaw angle is less than (is clockwise relative to the expected yaw angle when viewing the aircraft from the top) the expected yaw angle, the controller will increase effective brake pressure at a wheel (e.g., 15) on the left side of the aircraft.

In some embodiments, controller 100 is configured to detect an undesired yaw characteristic if a measured yaw rate deviates from an expected yaw rate by a deviation limit. For example, in the present embodiment, system 10 is not limited to detecting and/or reducing undesired yaw characteristics during straight-line motion. In such embodiments, a measured yaw rate (rate of change of yaw angle) can be compared to an expected yaw rate, and an undesired yaw characteristic detected when the measured yaw rate exceeds the expected yaw rate by a deviation limit (e.g., one degree per second, five degrees per second, 0.1 degrees per millisecond, or the like). That is, if the aircraft is turning or being steered or directed through an intended turn, the yaw angle will generally shift along the path of the turn (or curve) such that an expected yaw rate can be determined from the characteristics of the turn (e.g., radius, etc.) and the speed and/or velocity of the aircraft. In some embodiments, controller 100 is configured to receive a signal from a steering input sensor of a light aircraft to determine an expected yaw change. For example, controller 100 can be configured to receive a signal from a sensor coupled to one or more steering systems of the aircraft such that the controller can determine when a turn is intended or directed by a pilot and/or the characteristics of the turn, such that the controller can determined an expected yaw change that can, in turn, be compared to a measured yaw change.

In some embodiments, controller 100 is configured to detect an undesired yaw characteristic if fluctuation in a measured yaw rate exceeds a fluctuation limit. For example, when a pilot panics or manually over-corrects and/or under-corrects, the yaw rate may vary rapidly (e.g., in a “fishtail” motion) such that it may be advantageous for system 10 to apply some corrective force to the aircraft to stabilize the yaw angle fluctuation.

In some embodiments, system 10 (e.g., controller 100) is configured to identify or detect when a pilot's actions are improper and/or are likely to be detrimental. For example, pilots of light aircraft are often much less experienced and/or less trained than commercial pilots, and may be more likely to improperly overcorrect in the event of cross winds or other sudden disturbances. Some embodiments of system 10 (e.g., controller 100) are configured to permit the operator full authority over the system (e.g., by not reducing brake pressure initiated by a pilot, the pilot is able to increase the pressure on any individual wheel/brake system such as to stop the plane). In contrast, automotive ABS systems reduce pressure to prevent wheels from locking up, such that no matter how hard the brake pedal in a car with ABS is pressed, the system generally will not permit a driver to override the ABS system in real-time. However, embodiments of system 10 (e.g., controller 100) are configured such that the system will not prohibit a pilot from any action that he or she would normally be able to make; such as locking up one wheel (or one gear leg for larger aircraft) at low speed, such as, for example, to make tight turns on parking ramps or other areas such action might normally be conducted.

To reduce the likelihood of danger, controller 100 can be configured to have limited authority to override an operator's (pilot's) control over the aircraft such that controller 100 can send a signal to one or more steering systems to provide corrective action (even if opposed to the pilots actions or steering inputs). For example, controller 100 is configured to determine whether the pilot is acting correctly (e.g., safely) or if the operator's actions are detrimental to the course of the aircraft. For example, the controller 100 can determine whether the aircraft is oscillating unsafely (e.g., too rapidly, at a harmonic frequency, and/or otherwise, such that the aircraft is in danger of overturning, crashing, and/or being uncontrolled or uncontrollable by a pilot) about a straight line course (e.g., due to a pilot's correction and subsequent over-correction). Such back and forth motion (oscillations) often result in an accident when the oscillations become too large and the aircraft spins around it's vertical axis, or runs off the runway. As described in this disclosure, controller 100 can send a signal to initiate one or more corrective forces to dampen the oscillation to either zero, or a level that is manageable by the pilot. In some embodiments, controller 100 is configured such that controller 100 can initially override a pilot's actions, and such that the pilot can immediately switch off, override, and/or pause (e.g., for a period of seconds or minutes, such as for example, 10, 20, 30, 40, 50, or more seconds, or 1, 2, 3, 4, 5, or more minutes) system 10 such that controller 100 does not counteract the pilot's actions or inputs while switched off or paused.

In some embodiments, controller 100 is configured such that if the measured yaw characteristic (e.g., angle, rate, fluctuation or the like) approaches a predetermined maximum (e.g., a manufacturer's maximum yaw characteristic for a specific aircraft that is likely to cause the aircraft to capsize or result in a rollover, a maximum yaw characteristic for a class of aircraft that is likely to result in a rollover, and/or any other maximum yaw characteristic), controller 100 will signal to the pilot (e.g., via a visual and/or audible alarm in the cockpit) that the yaw the aircraft is in danger of rolling over and/or will rollover. For example, as the measured yaw characteristic approaches or nears (e.g., is increasing toward, comes within a range of a predetermined maximum yaw characteristic (e.g., within 1, 2, 3, 4, 5, or more degrees of a predetermined maximum yaw angle; within 1, 2, 3, 4, 5, or more degrees per second of a predetermined maximum yaw rate), and/or reaches the predetermined maximum for the yaw characteristic, controller 100 is configured to send a signal to a warning light and/or audible alarm in the cockpit and/or perceivable by a pilot of the aircraft to warn or alert the pilot that the aircraft is in danger of rolling over. In some embodiments, controller 100 is configured such that if the measured yaw characteristic approaches a predetermined maximum yaw characteristic, controller 100 will increase effective brake pressure in a portion of the brake system to reduce the likelihood of the aircraft rolling over. In such embodiments, system 10 is configured to provide rollover protection for the aircraft (e.g., to protect passengers, cargo, and the pilot).

In some embodiments, controller 100 is configured such that if the measured yaw characteristic approaches a predetermined maximum, the controller will actuate one or more additional steering systems (e.g., primary flight control system and/or propulsion system) of the aircraft to reduce the likelihood of the aircraft rolling over. In some embodiments, controller 100 is configured to record or store (e.g., in memory, hard drive, or the like) measured yaw characteristics of the aircraft, actions and/or signals of controller 100, and/or the effect of such actions and/or signals on the aircraft, such as, for example, in a storage component of controller 100 and/or by transmitting such information to an external storage device such as what is commonly referred to as a “black box” of an aircraft.

In any of the present embodiments of system 10 and/or controller 100, such that the actuation of one or more steering systems is in relation to (e.g., proportional to and/or varied with) the magnitude of variation between a measured yaw characteristic and an expected yaw characteristic. For example, if a measured yaw angle varies from an expected yaw angle by a large angle (e.g., 60 degrees), controller 100 can send a signal to increase effective force in the braking system by a relatively large amount. In some embodiments, controller 100 is configured to make a determination based upon the reaction of the aircraft to previous signals from controller 100 and/or corrective forces initiated by such signals, and to modify or maintain the signal in order to stabilize the yaw characteristics of the aircraft. For example, controller 100 can be configured to monitor the measured yaw characteristic in substantially real-time such that once the initial corrective action is undertaken (e.g., effective brake pressure increased) and the deviation of the measured yaw characteristic from the expected yaw characteristic decreases, the magnitude of the corrective action can be decreased as the measured yaw characteristic becomes closer to the expected yaw characteristic. For example, if brake pressure is initially boosted by 50% for a deviation of 50% from an expected yaw characteristic, as the deviation decreases (e.g., to 40%, 30%, 20%, 10%), the brake pressure boost can also be decreased (e.g., to 40%, 30%, 20%, 10%).

Controller 100 can comprise any suitable hardware that can be programmed or otherwise configured to function as described in this disclosure. For example, controller 100 can comprise one or more of any of (e.g., components selected from the group consisting of) computers, processors, memory, field-programmable gate arrays (FPGAs), motherboards, and/or any other suitable control hardware. Controller 100 can be configured (e.g., programmed) to receive one or more signals from yaw sensor 104, and to determine and output a signal to actuate one or more steering systems to correct an undesirable yaw characteristic.

Yaw sensor 104 can comprise one or more gyroscopes, accelerometers, and/or rotational sensors (e.g. two rotational sensors each coupled to a wheel on a different side of the aircraft to detect unexpected differentials that would indicate unexpected or undesired turning or yaw). In some embodiments, yaw sensor 104 can comprise a rotational sensor or other sensor configured to measure the direction of a single wheel that is pivotally coupled to the aircraft (e.g. nose wheel 16) such that the yaw angle of the aircraft can be determined and/or approximated from the direction of the single wheel (at least when the wheel is in contact with a surface such as a runway). In some embodiments, controller 100 comprises two or more redundant processors and/or is configured to communicate with redundant sensors (e.g., one or more redundant yaw sensors 104) such as, for example, to increase reliability and decrease the likelihood of failure of system 10. For example, yaw sensors 104 can comprise two or more sensors configured to measure yaw characteristics of the aircraft in two or more different ways (e.g., gyroscopes and accelerometers) such that controller 100 can compare measured yaw characteristics from two or more different sensors to determine whether an error may have occurred in one of the two or more yaw sensors, and/or verify a measured yaw characteristic of the aircraft when the two or more yaw sensors are in agreement with one another.

In embodiments of system 10 utilizing redundant sensors and/or processors, sensors and processors can be configured to communicate with each other to validate accurate data in what may be known as “watchdog” circuits. Further, controller 100 can comprise watchdog (e.g., monitoring) programs or executable code to monitor the accuracy of data streams (e.g., from any of various sensors). For example, multiple (e.g., two, three, four, five, or more) sensors can be utilized to measure a single characteristic such that controller 100 can compare the signals received from the sensors to verify that the data is accurate (e.g., it is unlikely that all redundant sensors will fail simultaneously). Such watchdog circuits and/or programs can comprise sub programs and/or sub- or aux-processors to monitor the status and/or function of system 10. Other means of redundancy or programming may be utilized to enhance the overall function, reliability, and/or safety of system 10.

In some embodiments, system 10 can comprise (and/or controller 100 can be configured to receive signals from) additional input sensors 112. For example, one or more sensors 112 can be coupled to aircraft 12, and controller 100 can be configured to receive one or more signals from sensors 112, such that controller 100 can detect or determine if system 10 should be active. For example, in embodiments of controller 100 configured to send signals only to the braking system of the aircraft, sensor 112 can comprise one or more sensors configured to sense when the landing gear of the aircraft is deployed and/or in contact with a surface (e.g., a runway) such that controller 100 can activate system 10 when the wheels (e.g., 14, 15) are in contact with a surface and braking the wheels is likely to be or will be effective to affect the yaw characteristics of the aircraft, and/or can deactivated system 10 when the landing gear is not deployed or when the wheels are not in contact with a surface. In some embodiments, only portions of system 10 are deactivated in certain circumstances. For example, controller 100 can be configured to not send signals to the brake system during flight.

Sensors 110 and/or 112 and/or controller 100 can be configured such that controller 100 can determine or detect the desired and/or directed direction of travel of the aircraft, the desired and/or directed rate of deviation from a straight line course, and/or any other desirable input, such as, for example landing gear position, wheel speed, and the like. Additionally, system 10 can be configured such that controller 100 can inform a pilot of the condition of system 10 and/or of any corrective action being taken by controller 100 and/or system 10, such as, for example, by way of outputs 114 to a display, indicator light, audible signal, and/or the like in the cockpit or perceivable by a pilot in the cockpit of the aircraft.

In embodiments of system 10 configured to function during flight of an aircraft, sensors 110 and/or 112 can comprise sensors configured to measure characteristics sufficient for controller 100 to determine and/or detect engine condition, aircraft flight behavior (e.g., airspeed and/or the like). Controller 100 can be configured to send signals to actuate or control flight surfaces (e.g., rudder, flaps, etc.) of the primary flight control system (e.g., to compensate for asymmetric thrust loads from a loss of engine power, and/or other factors). Such flight surfaces can be controlled via hydraulic actuators, electric motors or servos, or other suitable actuators.

In some embodiments, system 10 is configured to maintain the aircraft on the operator's chosen path, regardless of whether that path is curved, turning, or straight. In some embodiments, system 10 is not configured to function as an antilock braking system (abs) or traction control device. For example, in some embodiments, controller 100 is configured such that controller 100 will not send a signal to reduce the brake pressure below the brake pressure caused by a pilot's actuation of the brake system. For example, in an ABS system, brake pressure (caused by a driver's depression of a brake pedal) is intermittently reduced to prevent wheels (and tires) from losing traction. In contrast, embodiments of system 10 can be configured such that any brake pressure caused by a pilot's depression of a brake pedal in the aircraft is not reduced by any signals sent by controller 100 (e.g., such that if controller 100 sends a signal to release any additional brake pressure initiated by controller 100, the brake pressure initiated by the pilot will remain in the brake system). In this way, embodiments of controller 100 can be configured to allow a wheel to lock up at specific times, such as, for example, when a pilot wishes to lock up a single wheel while permitting one or more other wheels to turn, e.g., to make a sharp turn during taxiing (in contrast to an automobile ABS system that is configured to prevent wheels from locking up). In further contrast to an automobile ABS or traction control system, embodiments of system 10 are configured to permit an aircraft (e.g., wheels 14, 15) to lock up and/or slide on a surface such as a runway, to reduce and/or eliminate undesired yaw characteristic. In other embodiments, ABS may be incorporated in the present system.

In embodiments configured to function with multi-engine aircraft, system 10 be configured to control or actuate one or more steering systems (e.g., primary flight control system and/or propulsion system) of an aircraft to minimize disturbances in yaw characteristics that may be caused by a sudden engine failure. Such embodiments differ from simple yaw dampers and autopilot systems because system 10 actively monitors and/or corrects undesired yaw characteristics, and the pilot provides all heading information.

In the embodiment shown, controller 100 is configured to receive a signal from a yaw sensor (e.g., 104) of a light aircraft (e.g., 12) having a brake system 200. As shown in FIG. 3, brake system 200 can comprise a brake-fluid reservoir 204, master cylinders 208 (e.g., each corresponding to a different wheel 14, 15), and brake calipers 212 (e.g., each corresponding to a different wheel 14, 15) configured to exert a braking force on a brake disc 216 coupled to a wheel 14 or 15. As shown, brake system 200 also comprise brake lines 220a and 220b (collectively, 220) coupling (and configured to couple) master cylinders 208 to reservoir 204 (e.g., via brake controller 116, when system 10 is coupled to the aircraft, as shown); and comprises brake lines 224a and 224b (collectively, 224) coupling (and configured to couple) master cylinders 208 to calipers 212. In the embodiment shown, controller 100 is also configured: to be coupled to the light aircraft (e.g., 12) such that controller 100 is in communication with the brake system of the aircraft; and such that if an undesired yaw characteristic of the aircraft is detected, controller 100 will send one or more signals to increase effective brake pressure in a portion of the brake system to decrease the undesired yaw characteristic. In the embodiment shown, system 10 comprises a brake controller 116.

In the embodiment shown, brake controller 116 comprises a pump 120 and two valves 124a and 124b (collectively, 124) configured to be coupled (and are shown coupled) to reservoir 204 and master cylinders 208. More particularly pump 120 is shown coupled to reservoir 204 by a conduit 128, individually coupled to each valve via conduits 132a and 132b (collectively, 132); and individually coupled to reservoir 204 via conduits 136a and 136b (collectively, 136). Pump 120 can be a hydraulic pump (e.g., an electrically actuated hydraulic pump) configured to be actuated to pressurize brake fluid in conduits 132a and 132b and, when permitted by valves 124, in brake lines 220. Valves 124a and 124b are configured to be coupled to controller 100, pump 120, reservoir 204 and brake lines 220 (and 224), as shown. In this configuration, pumps 124 can each be configured such that when the valve is not powered (e.g., in its first or closed position), the valve connects the respective brake line 220 to conduit 136 and reservoir 204 (e.g., such that pressure can be vented from the master cylinder) and the valve blocks the pump (e.g., prevents communication between conduit 132 and brake line 220). Pumps 124 can each further be configured such that when the valve is powered (e.g., in its second or open position), communication is permitted between conduit 132 and brake line 220, and communication is blocked or prevented between brake line 220 and conduit 136.

In the embodiment shown, brake controller 116 is configured such that the master cylinders (and brake pedals) connect directly to brakes calipers 212 (e.g., such that there is no interruption or potential points of failure introduced between the pilot's feet (brake pedals) and brake calipers 212), such as, for example, to help ensure that the pilot never looses the ability to apply the brakes of the aircraft. More particularly, components of system 10 (e.g., pump 120 and valves 124) are installed between reservoir 204 and master cylinders 208. In the absence of system 10, master cylinders 208 would couple directly to reservoir 204. As such, when valves 124 are off or in a closed position, the reservoir 204 and master cylinders 208 function as they would in the absence of system 10. The only circumstance in which system 10 (e.g., braking controller 116) affects operation of the aircraft braking system is when the valves are turned on or opened such that high-pressure brake fluid is permitted to flow from pump 120 through valves 124, through master cylinders 208 and to brake calipers 212. As such, braking controller 116 can be configured such that a pilot never looses the ability to brake the aircraft because the brake pedals in the cockpit can be still be depressed to actuate master cylinders 208 and increase braking pressure.

As illustrated, master cylinders 208 will typically include a piston 236 disposed in a cylinder 240 such that when the piston is not depressed (all the way up) a top port 244 (coupled to brake line 220) is open and fluid flows through the cylinder and out a bottom port 248 (coupled to brake line 224). When a pilot depresses a brake pedal, piston 236 is depressed and moves below top port 244. Even when the brake pedal and piston 236 of the master cylinder are depressed, however, pump 120 and valves 124 can be actuated (e.g., by a signal from controller 100) to add pressure via top port 244 because the additional pressure will press against the top of piston 236 to depress piston 236 further and thereby add pressure to brake line 224 via port 248. Master cylinder 208 can be configured such that piston 236 will never block top port 244 (e.g., is either above or below port 244).

In the embodiment shown, reservoir 204 include three ports, one each coupled to conduits 128, 136a, and 136b, respectively. In other embodiments, reservoir 204 can include only a single port and all three conduits 128, 136a, 136b can be coupled to the single port in any suitable fashion or fitting (e.g., via a one-to-three splitter, a tee connection, or the like). In other embodiments, system 10 can comprise a parking brake (e.g., a valve coupled to conduits 136 to prevent pressure from venting from brake lines 220 such that a pilot can apply pressure to the brakes and then close this valve).

Valves 124a and 124b each correspond to wheels on different sides of the aircraft (e.g., valve 124a corresponds to wheel 14, and valve 124b corresponds to wheel 15) such that each valve can be actuated to increase effective braking pressure on the corresponding wheel. In the embodiment shown, valves 124 are each configured such that when the valve is in a first position brake fluid is permitted to flow from the brake line (and/or the master cylinder, and/or the pump) to the reservoir but not from the pump to the brake line, and when the valve is in a second position brake fluid is permitted to flow from the pump into the brake line. For example, when valve 124 is in a first position brake fluid is permitted to flow from brake line 220a (and pump 120, and master cylinder 208) to reservoir 204 via conduit 136a but not from pump 120 to brake line 220a, and when valve 124 is a second position, brake fluid is permitted to flow from pump 120 to brake line 220a. In some embodiments, brake controller 116 comprises as separate processor, FPGA, or the like to receive signals from controller 100 and send signals to pump 120 and/or valves 124 to increase effective brake pressure. In other embodiments, controller 100 communicates directly with pump 120 and/or valves 124.

In some embodiments, pump 120 is configured to be coupled to controller 100 such that controller 100 can send signal to actuate pump 120 to provide varying levels of pressure in conduits 132 and/or brake lines 220. In some embodiments, valves 124 and/or pump 120 are configured to be coupled to controller 100 such that controller 100 can send a signal to actuate valves 124 and/or pump 120 to provide varying levels of pressure in brake lines 220. For example, controller 100 can send a signal to pump 120 to cause pump 120 to begin pumping and pressurize brake fluid within conduits 132, and controller 100 can send a signal to valve 124 to cause valve 124a to be actuated from its first position to its second position to permit the pressure in conduit 132a to be transferred to or enter brake line 220a.

System 10 can be configured to send signals to pump 120 and/or valves 124 individually and/or in variety of combinations to apply braking control (e.g., to increase effective pressure in a portion of braking system 116 (e.g., at either or both of brakes lines 220 and calipers 212). For example, pump 120 can be switched on, and valves 124 actuated in a pulsed fashion, to transmit pressure from conduits 132 to brakes lines 220. Valves 124 can be pulsed at various frequencies to control the effective pressure in brake lines 220. Additionally, the duration of “on” pulses (when a valve 124 is in its second position) and “off” pulses (when a valve 124 is in its first position) can be varied via pulse width modulation (PWM). For example, the longer the duration of an “on” pulse (e.g., pulse in which a valve 124 is in the second position in which brake fluid is permitted to flow from pump 120 and conduit 132 to brake line 220), the greater the effective force applied to a brake line 220 and a corresponding caliper 212. Pump 120 can also be configured to provide varying pressures (e.g., such that controller 100 can send a signal to pump 120 to provide more or less pressure) to vary the effective pressure transmitted to (and thus, in) brake lines 220. Other (e.g., electrical, mechanical, electromechanical) structures and/or methods can also be used to boost and/or control effective pressure applied to brake lines 220 (e.g. in excess of pressure initiated by master cylinders 208), and/or wheel/axle friction. In some embodiments, controller 100 is configured to not pulse the valves (at least under certain conditions), and instead to actuate valves 124 in a steady state, on or off manner.

By way of example, controller 100 can be configured to send signals to valves 124 to pulses on and off in a square wave function. In one embodiment, pump 120 can comprise an electrically powered hydraulic pump that is configured to provide a variable pressure charge between about 150 pounds per square inch (PSI) and about 500 PSI (other embodiments of pump 120 can provide any suitable pressure, whether variable or not). Separate from the pressure charge of the pump, the control wave of the valve is substantially square (e.g., on or off at any given instant). For example, with a 450 PSI working pressure (pressure charge from pump 120) in this example the valves can be pulsed on or off at various frequencies, this provides the effective pressure on the brakes. If both valves 124 are turned on (actuated to their second position) and left on, brake lines 220 would experience 450 PSI of pressure; but if valves 124 are cycle on and off thirty (30) times per second, the effective force is substantially reduced (although pump still generates 450 PSI to brakes lines 220 when the valve is switched on, brake lines 220 experience a lower effective pressure because valves 124 are intermittently switched off). Controller 100 can be configured to actuate valves 124 in various pulsed wave formats. For example, equally spaced waves (on and off for equal time periods) can be used, or on and off time periods can be offset or unequal (e.g., on period may change and off period may remain constant, or vice versa), and/or both on and off time periods can be independently controlled.

In operation, this switching of a valve can be represented by a substantially square wave, but wave of the pressure imparted to brake lines 220 (e.g., brake fluid in brake lines 220) is not square. When a valve is opened there is a relatively short time period in which the pressure builds from the 0 to 450 PSI, when the valve is closed there is a relatively short time period in which the pressure falls from 450 to 0 PSI. When pump 120 is actuated to vary the pressure charge provided by the pump, this squareness of the wave may be further rounded or reduced (e.g., even more rounded as the pump pressure is changing). This change in pressure charged by the pump will most often occur over a relatively longer time period than the time period of the pulse, so the shorter the pulse the more square the wave; but when a pulse is sustained for a longer period the wave will be less square.

As noted, some embodiments of system 10 are configured to employ a combination of pulse width modulation (PWM) (e.g., brake valve pulses), and actuating pump 120 to provide variable pressure, to control effective pressure in brake lines 220 and calipers 212. In such embodiments, controller 100 can be configured to actuate pump 120 and/or valves 124 to reduce the perception of pulses by a pilot of the aircraft (e.g., via brake pedals or the like). When a valve 124 is pulsed, the pulse may be felt by a pilot via the brake peddle (as long as a pilot's foot is on the peddle, the pulse will likely be perceived because the pressure will energize the master cylinder). Controller 100 can be configured to (at least in some circumstances) apply pulses at a frequency high enough to be substantially non-perceivable by a pilot and/or to actuate the valves in a steady state manner. For example, by reducing or eliminating pulses at various speeds, comfort for the pilot can be improved and/or fatigue reduced (e.g., of the pilot and/or of system components). By varying the voltage of pump 120, the output pressure can be controlled. When a small effective pressure is required such as during low speed maneuvers, the output pressure of pump 120 can be reduced to provide the desired effective pressure. For example, if the required effective pressure at 5 mph is 150 PSI, then pump 120 can be adjusted by controller 100 to deliver 150 PSI, rather than pulsing one or both of valves 124 to reduce a pressure charge of 450 PSI down to an effective pressure of 150 PSI.

In this way, by regulating the pressure provided by pump 120, valves 124 can be actuated in steady state fashion while still achieving a desired effective pressure in brake lines 220. In circumstances in which rapid application of pressure is appropriate (e.g., sudden cross-wind gusts), valves 124 can be pulsed to gain a more rapid application of pressure to brake lines 220 and calipers 212. One benefit of steady state application of pressure, other than operator comfort, is that a reduction in pulses reduces vibration to minimize harmonic vibration and the like from the system.

In some embodiments (e.g., during pulsed operation), system 10 is configured to actuate pump 120 to provide a pressure charge that is greater than is expected to be needed. For example, if for given aircraft speed, a pressure charge of 400 PSI may be needed, the controller 100 may actuate pump 120 to provide a pressure charge of 450 PSI. This is to ensure that enough pressure will be present at any given instant, e.g., because the valves can be actuated to reduce effective pressure more quickly than the pump can be actuated to increase effective pressure. For example, when the aircraft is moving at elevated velocities (when stability may be more critical and the aircraft may be more difficult to control, the pump can be operated at a higher pressure and the pulses used to reduce the pressure charge to a desired effective pressure. In contrast, at lower speed, the aircraft may maneuvers so slowly that there is time to adjust the pressure at the pump without needing to pulse the valves.

In some embodiments, valves 124 may be omitted or may be left on during operation of system 10, such that controller 100 actuates pump 120 to provide all desired pressure changes. In other embodiments, system 10 can comprise and/or utilize accumulators or the like to control pressure, such that the pump can stay off until an undesired yaw characteristic is detected. Once an undesired yaw characteristic is detected, then the accumulator can be actuated to provide a desired effective pressure, and the pump actuated recharge the accumulator. In other embodiments, system 10 can comprise or utilize any suitable combination or configuration of (e.g., electrically adjustable) pressure regulators, valves, fluid orifices, and/or any other suitable structures for varying hydraulic pressure.

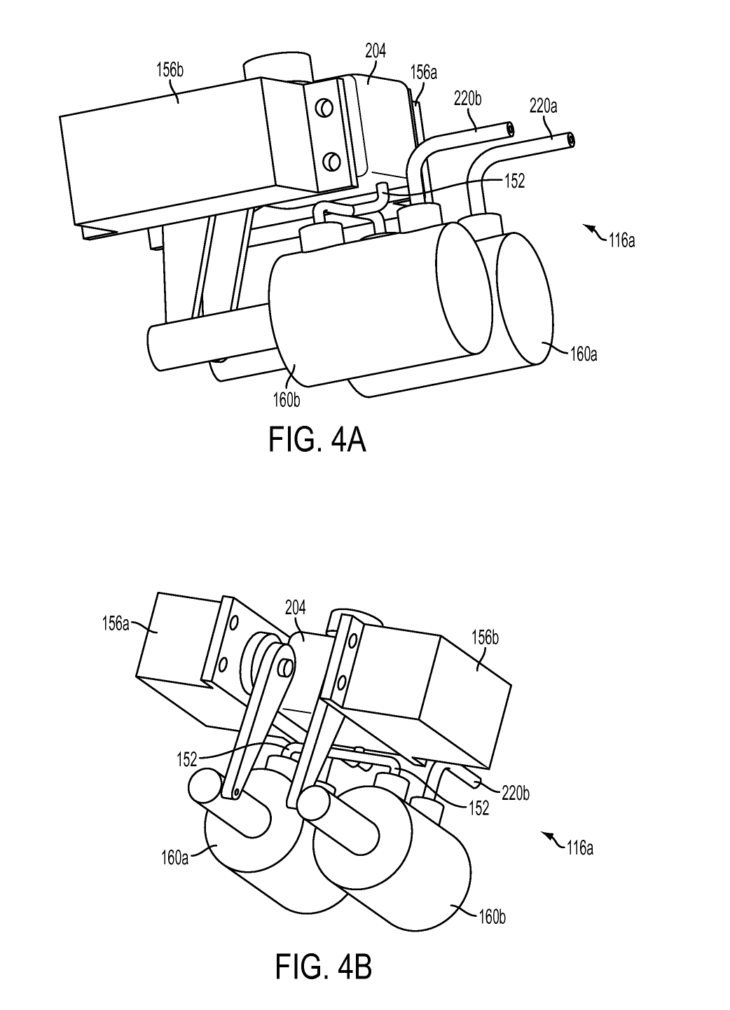

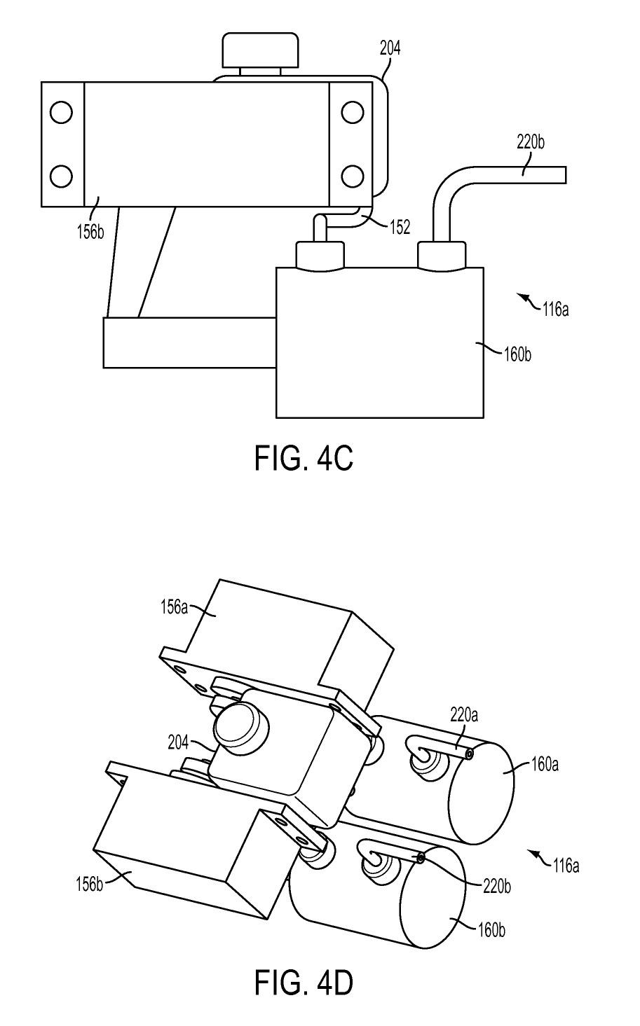

Referring now to FIGS. 4A-4D, an alternate embodiment of brake system controller 116a is shown. Controller 116a can replace controller 116 of FIG. 3 (e.g., pump 120 and valves 124). In the embodiment shown, controller 116a comprises two electric servos 156a, 156b (collectively, 156), and two hydraulic cylinders 160a, 160b (collectively 160). As indicated, when brake controller 116a is used included in system 10, cylinders 160 are configured to be (and are shown) coupled to reservoir 204 via conduits 152 (similar to conduits 132), and can be coupled to brake lines 220, such that cylinders 156 can be actuated to increase pressure in brake lines 220 in a manner similar to that described above generally and for valves 124. Servos 156 are configured to be (and are shown) coupled to cylinders 160 such that servos can be powered or actuated to actuate cylinders 160. For example, servos 156 are configured to be coupled to controller 100 such that controller 100 can send a signal to either or both servos 156 to cause either or both servos 156 to actuate the corresponding cylinder(s) 160. Controller 100 can be configured to actuate and/or sense the position of servos 156 using PWM signals and/or any other variable and/or static signals. Cylinders 160 are similar to master cylinders 208 described above. That is, when cylinders 160 are fully open (completely un-actuated) fluid flow is not impeded and communication is permitted between brake lines 220 and reservoir 204, and when cylinders 160 are actuated, fluid flow is prevented between brake lines 220 and reservoir 204 such that cylinders 160 can vary the pressure in brake lines 220 and at calipers 212. In embodiments of system 10 comprising brake controller 116a, system 10 and/or controller 100 can be configured to have any one or combination of features and/or functions described in this disclosure (e.g., for embodiments having brake controller 116).

In other embodiments, servos (e.g., similar to servos 156) can be coupled directly to brake pedals in the cockpit of the aircraft such that the servos can actuate master cylinders 208 via the brake pedals to increase pressure in the brake system. In other embodiments, servos (e.g., similar to servos 156) can be coupled directly to the pistons of calipers 212 to increase brake pressure directly at the calipers. In other embodiments, servos (e.g., similar to servos 156) can be coupled directly to respective pistons 236 of master cylinders 208 such that controller 100 can send one or more signals to the servos to actuate master cylinders 208 (in such embodiments, controller 100 can be coupled to a sensor configured to detect or measure the position of the brake pedals, such that the controller 100 will not actuate the servos to reduce the braking pressure applied by a pilot via the brake pedals).

In other embodiments, a single servo 156 and cylinder 160 can be coupled to both brake lines 220a, 220b by way of a switch valve that can be actuated by a signal from controller in a similar fashion to brake controller 116 of FIG. 3. In this way, controller 100 can send a signal to actuate servo 156 to, in turn, actuate cylinder 160 to generate a pressure charge; and switch valve can select either brake line 220a or brake line 220b to apply the pressure charge to the appropriate brake caliper 212. In further embodiments, other actuators (e.g., linear actuators, solenoids, and the like) can be used in place of, or in addition to, the servos described.

Various embodiments of the present methods include performing the various functions described above (e.g., any combination of: measuring yaw characteristics; measuring non-yaw characteristics such as flight and/or aircraft characteristics; determining expected yaw characteristics; comparing measured yaw characteristics to expected yaw characteristics; detecting or identifying an undesired yaw characteristic; sending a signal to initiate a corrective force to reduce and/or eliminate the undesired yaw characteristic; monitoring the measured yaw characteristic in real-time; continuously comparing one or more measured yaw characteristic to one or more expected yaw characteristics in real-time; and/or adjusting the corrective force as the measured yaw characteristic varies relative to the expected yaw characteristic.

The various illustrative embodiments of devices, systems, and methods described herein are not intended to be limited to the particular forms disclosed. Rather, they include all modifications, equivalents, and alternatives falling within the scope of the claims.

The claims are not intended to include, and should not be interpreted to include, means-plus- or step-plus-function limitations, unless such a limitation is explicitly recited in a given claim using the phrase(s) “means for” or “step for,” respectively.

1. A control system for a light aircraft, comprising:
a controller configured to receive a signal from a yaw sensor of a light aircraft having a brake system the controller also being configured:
to be coupled to the light aircraft such that the controller is in communication with the brake system of the aircraft; and
such that if an undesired yaw characteristic of the aircraft is detected, the controller will send one or more signals to increase effective brake pressure in a portion of the brake system to decrease the undesired yaw characteristic.

2. The system of claim 1, where the controller is configured to receive a signal from a yaw sensor that comprises a gyroscope.

3. The system of claim 1, where the controller is configured to receive a signal from a yaw sensor that comprises one or more accelerometers.

4. The system of claim 1, where the controller is configured to receive a signal from a yaw sensor comprising two rotation sensors each coupled to a different wheel of the aircraft.

5. The system of claim 4, where the controller is configured to measure the direction of a single wheel that is pivotally coupled to the aircraft.

6. The system of claim 1, where the controller is configured to detect an undesired yaw characteristic if a measured yaw angle deviates from an expected yaw angle by a deviation limit.

7. The system of claim 1, where the controller is configured to detect an undesired yaw characteristic if a measured yaw rate deviates from an expected yaw rate by a deviation limit.

8. The system of claim 6, where the controller is configured to receive a signal from a steering input sensor of a light aircraft to determine an expected yaw change.

9. The system of claim 1, where the controller is configured to detect an undesired yaw characteristic if fluctuation in measure yaw rate exceeds a fluctuation limit.

10. The system of claim 6, where the controller is configured such that if the measured yaw angle is greater than the expected yaw angle, the controller will increase effective brake pressure at a wheel on the right side of the aircraft, and where the controller is configured such that if the measured yaw angle is less than the expected yaw angle, the controller will increase effective brake pressure at a wheel on the left side of the aircraft.

11. The system of claim 1, where the controller is configured such that if the measured yaw characteristic approaches a predetermined maximum, the controller will signal to the pilot that the aircraft is in danger of rolling over.

12. The system of claim 1, where the controller is configured such that if the measured yaw characteristic approaches a predetermined maximum, the controller will modify effective brake pressure in a portion of the brake system to reduce the likelihood of the aircraft rolling over.

13. The system of claim 12, where the controller is configured such that if the measured yaw characteristic approaches a predetermined maximum, the controller will actuate one or more additional steering systems of the aircraft to reduce the likelihood of the aircraft rolling over.

14. The system of claim 13, where the one or more additional steering systems comprise one or more systems selected from the group consisting of: the propulsion system, and the primary flight control system.

15. The system of claim 12, where the controller is configured such that the controller will not reduce the brake pressure below the brake pressure caused by a pilot's actuation of the brake system.

16. The system of claim 1, further comprising:
a hydraulic pump configured to be coupled to a brake-fluid reservoir and brake lines of a light aircraft;
two valves configured to be coupled to the controller, the pump, the brake fluid reservoir, and different brake lines, each valve corresponding to wheels on different sides of the aircraft, each valve configured such that when the valve is in a first position brake fluid is permitted to flow from the brake line to the reservoir but not from the pump to the brake line, and when the valve is in a second position brake fluid is permitted to flow from the pump into the brake line; and
a yaw sensor configured to be coupled to the controller and a light aircraft to detect one or more yaw characteristics of the light aircraft.

17. The system of claim 16, where the hydraulic pump is configured to be coupled to the controller such that the controller can send a signal to actuate the pump to provide varying levels of pressure in the brake lines.

18. The system of claim 17, where the valves are configured to be coupled to the controller such that the controller can send a signal to actuate the valves to provide varying levels of pressure in the brake lines.

19. The system of claim 1, further comprising:
one or more hydraulic cylinders configured to be coupled to a brake-fluid reservoir and brake lines of a light aircraft;
one or more servos each configured to be coupled to a different one of the one or more hydraulic cylinders; and
a yaw sensor configured to be coupled to the controller and a light aircraft to detect one or more yaw characteristics of the light aircraft.

20. The system of claim 19, where the one or more servos are configured to be coupled to the controller such that the controller can send a signal to actuate each servo to in turn actuate a coupled hydraulic cylinder to provide varying levels of pressure in the brake lines.

21. The system of claim 20, where the valves are configured to be coupled to the controller such that the controller can send a signal to actuate the valves to provide varying levels of pressure in the brake lines.

22. A control system for a light aircraft comprising:
a controller configured to receive a signal from a yaw sensor of a light aircraft having one or more steering systems, the controller also being configured:
to be coupled to the aircraft such that the controller is in communication with the one or more steering systems of the aircraft, and
such that if an undesired yaw characteristic is detected, the controller will send one or more signals to actuate one or more steering systems of the aircraft to reduce the undesired yaw characteristic.

23. The system of claim 22, where the controller is configured to send a signal to one or more steering systems selected from the group consisting of: the brake system, the propulsion system, and the primary flight control system.
